(19) United States
(12) Patent Application Publication
(10) Pub. No.: US 2014/0016213 A1
(43) Pub. Date: Jan. 16, 2014

(54) Plastic injection molded lens for a left and a right rear-view mirror of an automobile

(71) Applicant: Chun-Chih Cheng, Tainan City (TW)

(72) Inventor: Chun-Chih Cheng, Tainan City (TW)

(21) Appl. No.: 13/507,550

(22) Filed: Jul. 10, 2012

(51) Int. Cl. G02B 17/00

(52) U.S. Cl. 359/726

(57) ABSTRACT

A plastic injection molded lens for a left and a right rear-view mirror of an automobile is injection formed into shape in a mold. The lens is formed integrally with a major mirror surface zone and a minor mirror surface zone that are different from each other in radian of curved surface. By so designing, the visual field of the rear-view mirror is much wider and produces no dead angles of vision; therefore, the rear-view mirror of this invention is needless to be adjusted for keeping away from the dead angles of eyesight.

### BACKGROUND OF THE INVENTION

1. Field of the Invention

This invention relates to a plastic injection molded lens for the left and the right rear-view mirrors of an automobile, particularly to one formed with two visual lines different in radian of curved surface to enable a driver to dodge dead angles of vision when he is driving a car.

2. Description of the Prior Art

Mirror systems are provided on vehicles to aid the operator of the vehicle in viewing other vehicles while merging, lane changing, turning, reversing, etc. Mirrors can provide a view of the vehicles and objects in the vicinity of the operator's vehicle. However, the effectiveness of that view depends on proper alignment of the mirrors. It is known in the art, through customer interviews, car clinics, and survey comments that many vehicle operators do not align their mirrors in an orientation which provides the most information to the operator.

In particular, it is common for drivers to position their exterior side mirrors so that they can see the edge of their own vehicle 10. As illustrated in FIG. 1, side mirrors 11 and 12 are adjusted such that their respective viewing regions, shown as 13 and 14, respectively, intersect the back corners of vehicle 10. In this position, the images of vehicles 15 and 16 are not provided to the driver by any of mirrors 11, 12 or in-cabin mirror 17. Also, it can be seen that the viewing angles of mirrors 11, 12, and 17 overlap significantly.

Properly adjusted exterior mirrors 11 and 12 are illustrated in FIG. 2. Images of vehicles 15 and 16 are at least partially in one of the viewing regions 13′ and 14′. Also, there is less overlap of viewing regions 13′ and 14′ with region 18. Also note that neither of viewing regions 13′ or 14′ intersect with vehicle 10, thereby making a more effective use of available image area of mirrors 11, 12, and 17 than that shown in FIG. 1.

A conventional vehicle rear-view mirror with two plane irradiation surfaces is made of glass and then such a rear-view mirror is heated and bent to form another irradiation surface, inconvenient in manufacturing and too high in processing cost. The irradiation surfaces of the conventional rear-view mirror are not curved surfaces so the observation range of the conventional rear-view mirror cannot be widened.

### SUMMARY OF THE INVENTION

The objective of this invention is to offer a plastic injection molded lens for a left and a right rear-view mirror of an automobile, which is formed with two visual lines different in radian of curved surface.

The plastic injection molded lens for a left and a right ear-view mirror of an automobile in the present invention is formed integrally with a major mirror surface zone and a minor mirror surface zone at one side of the major mirror surface zone. The major mirror surface zone and the minor mirror surface zone are different in radian of curved surface. By so designing, the automobile rear-view mirror of this invention enables a driver to observe the outer edges of an automobile body.

### BRIEF DESCRIPTION OF DRAWINGS

This invention will be better understood by referring to the accompanying drawings, wherein:

FIG. 1 is a diagrammatic top plan view illustrating improper mirror adjustment, according to the prior art;

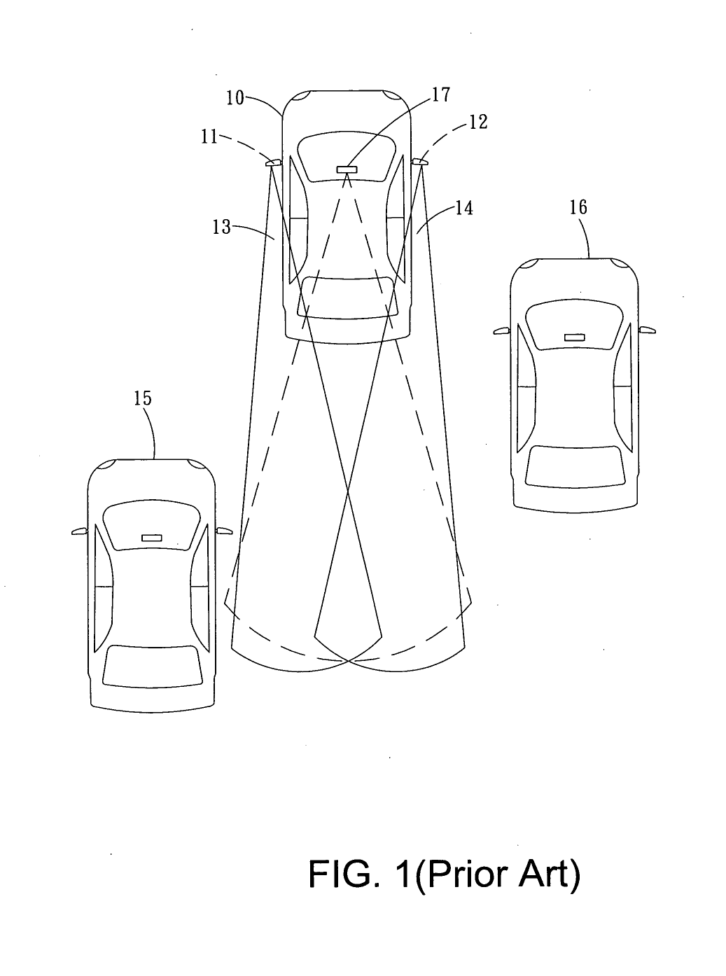

FIG. 2 is a diagrammatic top plan view illustrating proper mirror adjustment, according to the prior art;

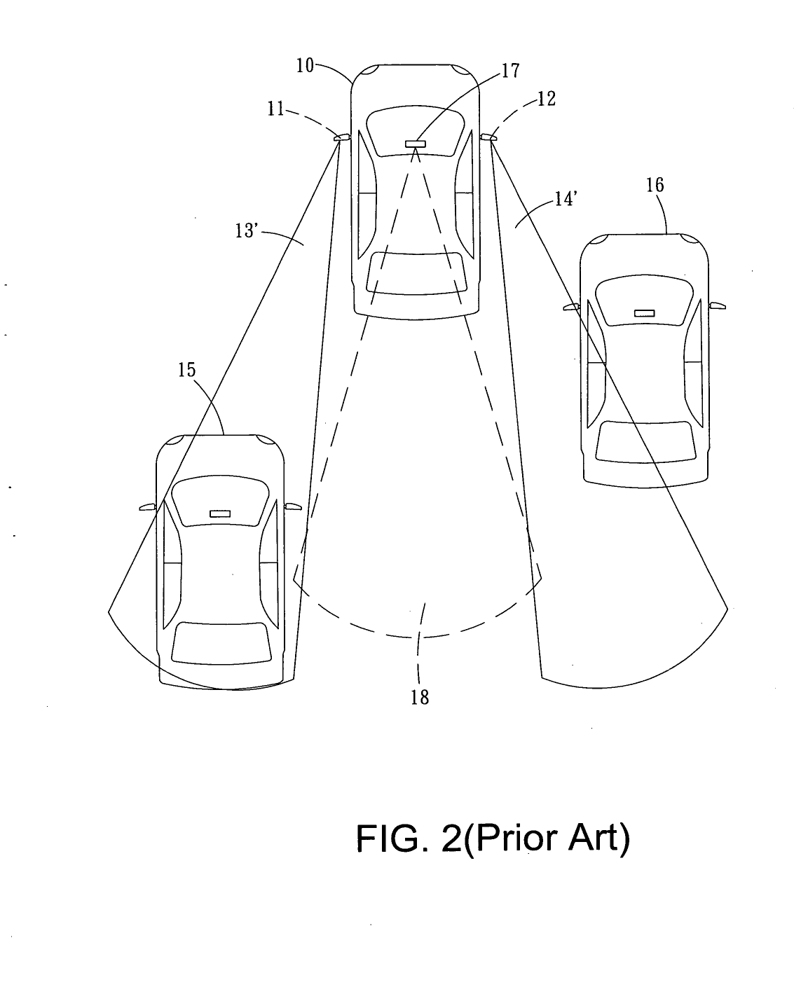

FIG. 3 is an exploded perspective view of the rear-view mirror in the present invention;

FIG. 4 is a perspective view of the rear-view mirror in the present invention; and

FIG. 5 is a diagrammatic top plan view illustrating the visual field of the minor mirror surface zone of the rear-view mirror in the present invention.

### DETAILED DESCRIPTION OF THE PREFERRED EMBODIMENT

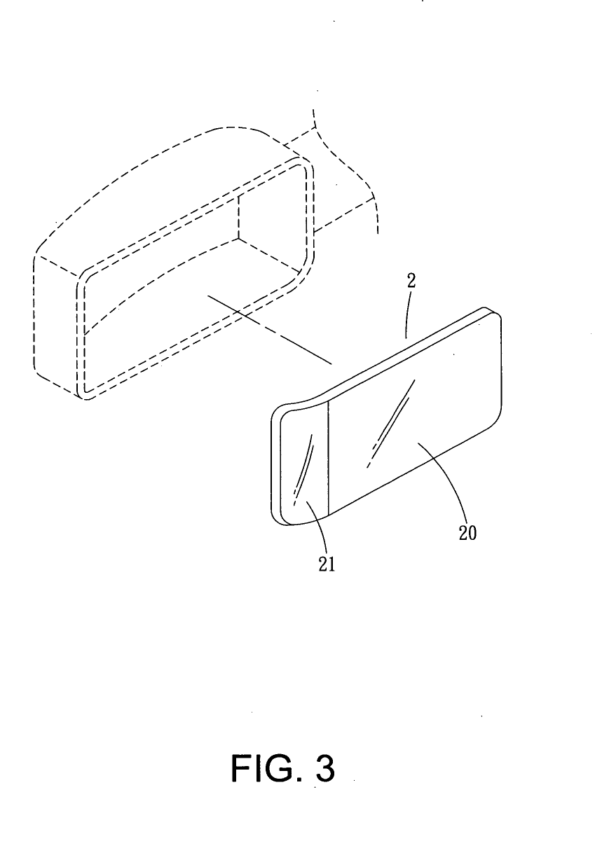

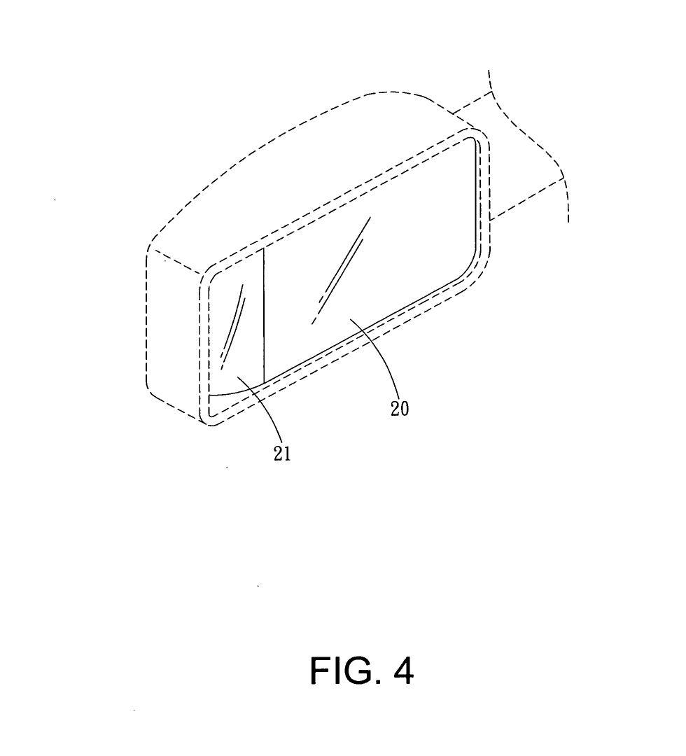

A preferred embodiment of a plastic injection molded lens 2 for the left and the right rear-view mirrors of an automobile in the present invention, as shown in FIGS. 3 to 5, is composed of a major mirror surface zone 20 and a minor mirror surface zone 21 combined together. The plastic material for making the lens 2 can be PC (polycarbonate), acrylic resin and the like. The major mirror surface zone 20 is formed with a comparatively large radiation zone for enabling a driver to observe the automobiles coming from behind, while the minor mirror surface zone 21, which is disposed at one side of the major mirror surface zone 20 and different from the major mirror surface zone 20 in included angle of radian, can be formed into curved surfaces, such as left and right curved surfaces, or upper and lower curved surfaces to enable the observation area of the minor mirror surface zone 21 to reflect the outer sides of the automobile body.

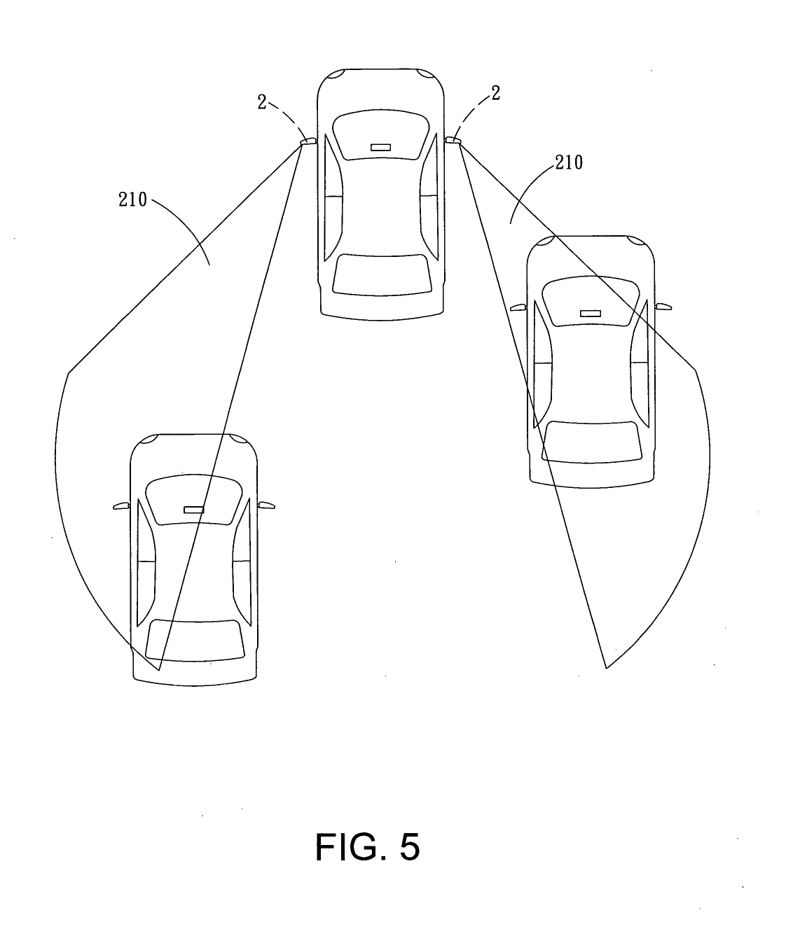

Specifically, the lens 2 of the rear-view mirror of this invention is to have one side of the major mirror surface zone 20 disposed with the minor mirror surface zone 21 slanting backward and formed with a curved surface. Thus, the major mirror surface zone 20 of the rear-view mirror is mainly employed for observing the automobiles coming from behind and the outer edges of the automobile body while the minor mirror surface zone 21 functions to observe the automobiles coming from two sides, able to greatly increase a rear viewing angle range, decreasing dead angles of vision. Apparently, the minor surface zone 21 of the rear-view lens 2 of this invention enables a driver to clearly observe two sides of the automobile to offer the driver a comparatively wide observation area 210, letting the driver obtain a better visual field of observation during making a turn or parking, as shown in FIG. 5.

Further, the lens 2 for an automobile rear-view mirror of this invention is formed by injection so it is needless to be processed for bending the lens 2 into an angle, easy and convenient in manufacturing the lens 2 for the rear-view mirror of an automobile.

To sum up, the plastic injection molded lens for the left and the right rear-view mirror of an automobile is formed with a major mirror surface zone 20 and a minor mirror surface zone 21 combined together, able to greatly enlarged a rear viewing angle range and hence reduce dead angles of vision. Thus, it is able to insure safety when the automobile changes lanes makes a turn, pulls over for parking and moves backwards, letting a driver relaxed and contented when driving an automobile.

While the preferred embodiment of the invention has been described above, it will be recognized and understood that various modifications may be made therein and the appended claims are intended to cover such modifications that may fall within the spirit and scope of the invention.

What is claimed is:

1. A plastic injection molded lens for a left and a right rear-view mirror of an automobile for observing the automobiles coming from two sides and from behind and observing road conditions, said lens for an automobile rear-view mirror formed integral by a plastic injection mold, said lens composed of a major mirror surface zone and a minor mirror surface zone provided at one side of said major mirror surface zone, said minor mirror surface zone being different from said major mirror surface zone in radian of curved surface, said minor mirror surface zone employed for observing the outer edges of an automobile body.

2. The plastic injection molded lens for a left and a right rear-view mirror of an automobile as claimed in claim 1, wherein the surface of said lens itself of said rear-view mirror is formed as a plane surface.

3. The plastic injection molded lens for a left and a right rear-view mirror of an automobile as claimed in claim 1, wherein said lens of said rear-view mirror has one side integrally extended and formed with said minor mirror surface zone.

4. The plastic injection molded lens for a left and a right rear-view mirror of an automobile as claimed in claim 1, wherein said minor mirror surface zone is formed as a curved surface.

5. The plastic injection molded lens for a left and a right rear-view mirror of an automobile as claimed in claim 1, wherein said plastic is PC (polycarbonate), acrylic resin or the like.
